(19) United States
(12) Patent Application Publication
(10) Pub. No.: US 2018/0019494 A1
(43) Pub. Date: Jan. 18, 2018

(54) REGENERATION OF FUEL CELL ELECTRODES

(71) Applicant: LG Fuel Cell Systems Inc., North Canton, OH (US)

(72) Inventors: Zhien Liu, Canal Fulton, OH (US); Joe Deering, Hartville, OH (US)

(73) Assignee: LG Fuel Cell Systems Inc., North Canton, OH (US)

(21) Appl. No.: 15/208,439

(22) Filed: Jul. 12, 2016

(51) Int. Cl. H01M 8/18; C25B 1/04; H01M 4/86

(52) U.S. Cl. CPC H01M 8/186; H01M 4/8652; C25B 1/04; H01M 2008/1293; H01M 2004/8689

(57) ABSTRACT

A method of operating a fuel cell system is provided. The fuel cell system may comprise one or more solid oxide fuel cells. One or more of the fuel cells may be operated in a fuel cell mode under an average current density of 100 to 1000 mA/cm² for a period of at least five hundred hours. The method may further comprise operating at least one of the fuel cells in an electrolyzer mode under an average current density from 100 to 1500 mA/cm², which may be applied for at least one hour. The ratio of the average current density in the electrolyzer mode to the average current density in the fuel cell mode may be at least one but no more than two and one-half.

### FIELD

This disclosure generally relates to fuel cells. More specifically, this disclosure is directed to methods which regenerate the performance of fuel cell electrodes.

### BACKGROUND

A fuel cell is an electrochemical system in which a fuel (such as hydrogen) is reacted with an oxidant (such as oxygen) at high temperature to generate electricity. One type of fuel cell is the solid oxide fuel cell (SOFC). The basic components of a SOFC may include an anode, a cathode, an electrolyte, and an interconnect. The fuel may be supplied to the anode, and the oxidant may be supplied to the cathode of the fuel cell. At the cathode, electrons ionize the oxidant. The electrolyte comprises a material that allows the ionized oxidant (or proton, depending on the particular fuel cell design) to pass therethrough to the anode while simultaneously being impervious to the fluid fuel and oxidant. At the anode, the fuel is combined with the ionized oxidant in a reaction that generates heat and releases electrons that are conducted back to the cathode through the interconnect.

The performance of a fuel cell may decrease over time as the fuel cell components degrade. The cathode is believed to be a major contributor to the degradation of fuel cells. A cathode may be subjected to migration of cathode material either to the interface of the cathode and cathode current collecting layer or to the interface of the cathode and the electrolyte depending on the fuel cell operating mode, migration of non-cathode materials into the cathode, reactions with other fuel cell components and materials, and decomposition during fuel cell operations.

There remains a need to inhibit and reverse electrode degradation caused by normal fuel cell operations.

### SUMMARY

In accordance with some embodiments of the present disclosure, methods of operating a fuel cell system to regenerate electrode performance are provided. After operating the fuel cell in electrical power generating mode (which may be referred to as a “fuel cell mode”) for some period, such as, e.g., 500 to 10,000 hours, the method may comprise applying a reverse current mode (which may be known as “electrolysis mode” or “electrolyzer mode”) to the fuel cell. The electrolysis mode may cause an electrode, such as, e.g., a cathode, to experience a chemical change, microstructural change, or both which reverses the degradation of the electrode. Reversing electrode degradation allows recovery of the electrode performance, and, therefore, fuel cell performance and extends the service life of the fuel cell system. The disclosed methods may be applied to the fuel cell at any time, and preferably, during periods of lower electrical power demand. The disclosed methods may be applied to any fuel cell, including, preferably, a SOFC.

In accordance with some embodiments of the present disclosure, a method of operating a fuel cell system is provided. The fuel cell may be a solid oxide fuel cell. The method may comprise operating one or more of the fuel cells of the fuel cell system in a fuel cell mode under an average current density from 100 to 1000 mA/cm² for a period of at least five hundred hours and operating at least one of the fuel cells in an electrolyzer mode under an average current density from 100 to 1500 mA/cm². The at least one fuel cell may be operated in an electrolyzer mode for at least one hour.

In accordance with some embodiments of the present disclosure, a method of operating a solid oxide fuel cell is provided. The method may comprise operating one or more fuel cells in a fuel cell mode under an average current density from 100 to 1000 mA/cm² for at least one thousand hours. The method may further comprise operating at least one of the fuel cells in an electrolyzer mode under an average current density from 600 to 800 mA/cm² for a period of at least one hour.

In accordance with some embodiments of the present disclosure, a method of operating a fuel cell system is provided. The method may comprise operating one or more fuel cells of said fuel cell system in a fuel cell more at a first average current density. The method may further comprise operating at least one of said fuel cells in a electrolyzer mode at a second average current density, wherein the ration of the second average current density in the electrolyzer mode to the first average current density in the fuel cell mode is at least one but no more than two and one-half

These and many other advantages of the present subject matter will be readily apparent to one skilled in the art to which the disclosure pertains from a perusal of the claims, the appended drawings, and the following detail description of the embodiments.

### BRIEF DESCRIPTION OF THE DRAWINGS

FIG. 1 is a diagram of a fuel cell in accordance with some embodiments of the present disclosure

FIG. 2 illustrates the AC impedance of a fuel cell after being operated in electrolysis mode at 200, 400, 600 and 800 mA/cm² (Bode plots).

FIG. 3 illustrates the area specific resistance of a fuel cell after being operated in electrolysis mode at 200, 400, 600 and 800 mA/cm² (Nyquist plots).

FIG. 4 illustrates the AC impedance of a fuel cell after being operated in electrolysis mode at 800 and 1000 mA/cm² (Bode plots).

FIG. 5 illustrates the area specific resistance of a fuel cell after being operated in electrolysis mode at 800 and 1000 mA/cm² (Nyquist plots).

FIG. 6 illustrates the AC impedance of a baseline fuel cell after being held under open current voltage conditions while an experimental fuel cell is operated at different reverse currents (Bode plots).

FIG. 7 compares the long term performance of a fuel cell periodically operated in reverse current mode to a fuel cell held under open current voltage conditions.

Referring to the drawings, some aspects of non-limiting examples of a fuel cell system in accordance with an embodiment of the present disclosure are schematically depicted. In the drawings, various features, components and interrelationships therebetween of aspects of an embodiment of the present disclosure are depicted. However, the present disclosure is not limited to the particular embodiments presented and the components, features and interrelationships therebetween as are illustrated in the drawings and described herein.

### DETAILED DESCRIPTION

The objectives and advantages of the claimed subject matter will become apparent from the following detailed description of the preferred embodiments thereof in connection with the accompanying drawings.

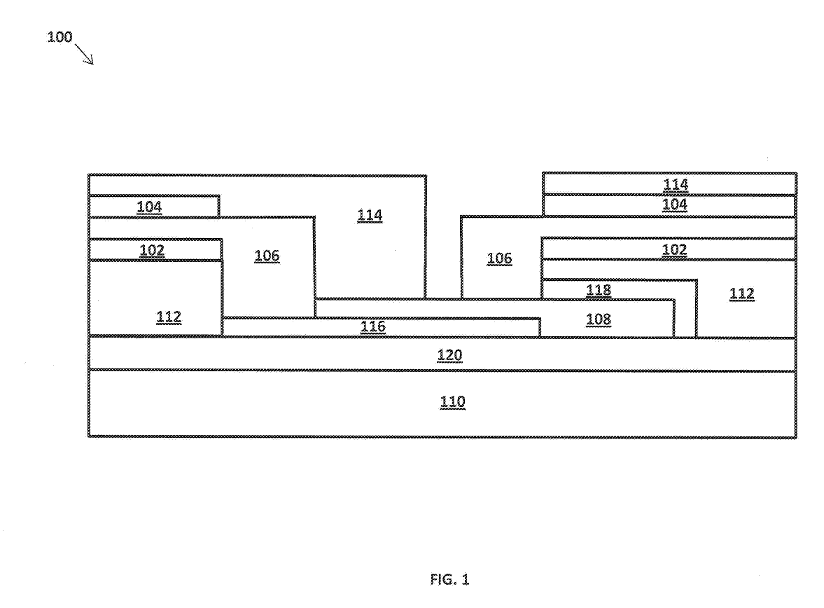

In accordance with some embodiments of the present disclosure, a fuel cell 100 is illustrated in FIG. 1. The fuel cell 100 comprises anode 102, cathode 104, electrolyte 106, interconnect 108, and porous substrate 110. The fuel cell 100 may further comprise anode current collector 112, cathode current collector 114, dense barrier layer 116, chemical barrier 118, and porous anode barrier 120. The active layers of the fuel cell 100 are printed on the porous substrate 110, which may be a tube wherein fuel or an oxidant (such as, e.g., air) is supplied to the electrodes. A plurality of electrochemical cells are printed on the same substrate 110 and may be connect in series. A plurality of tubes can be electrically and physically connected into a bundle, and multiple bundles can be connected and configured to form a strip or block . A fuel cell system may comprise multiple integrated blocks.

As the fuel cell is operated, various components may suffer from degradation which hampers the performance of the fuel cell and can be seen by at least an increase in fuel cell area specific resistance (ASR). For instance, an electrode, such as, e.g., a cathode, may undergo various changes which will degrade the electrode during fuel cell operations. Accelerated degradation may occur after around 8,000 hours of fuel cell operations and operations at higher temperatures, such as, e.g., 900 degrees Celsius. Key degradation mechanisms for a LSM cathode may include: the segregation of free MnO from the LSM phase due to increased oxygen vacancy under low pO₂; accumulation of free MnOₓ near the electrolyte interface that will occupy the triple phase boundary; and, densification, particularly of the LSM phase, near the electrolyte interface that results in a reduction of the triple phase boundary and a higher resistance to oxygen diffusion. These effects can cause the loss of the triple phase boundary, loss of catalytic activity, increased ASR, and lower power output.

After some period of time of fuel cell mode operations, such as, e.g., 500 to 10,000 hours, the fuel cell stack can be operated in electrolysis mode. In electrolysis mode, a reverse current is applied to the fuel cell stack causing it to operate as an electrolyzer that generates hydrogen at the anode and oxygen at the cathode. The reverse current may be applied for a shorter period of time than that during which the fuel cell was operated in fuel cell mode, and at current levels approximately equal to or greater than those generated by the fuel cell. These operations may restore the cathode microstructure, restore the triple phase boundary, decrease the resistance to the flow of oxygen, and extend the service life of the fuel cell.

In accordance with some embodiments of the present disclosure, a method of operating a fuel cell, such as, e.g., a SOFC, system is presented. The fuel cell system may comprise one or more fuel cells comprising a LSM-, LSF-, or LSCF-based cathode, or other composite cathode, in a segmented-in-series fuel cell design. The composition of the LSM-based cathode may be (La₁₋ₓSrₓ)MnO_{3-δ}-10ScSZ. However, this method is not limited to segmented-in-series fuel cells or the particular LSM composition listed above and may be applied to other cell designs, such as, e.g., anode-supported or electrolyte-supported planar fuel cells, and other cathode materials such as, e.g., a perovskite cathode having an ionic phase, wherein the perovskite can be PSM ((Pr₁₋ₓ Srₓ)MnO_{3-δ}), LSCF (La₁₋ₓSrₓ)(Co_{1-y}Fe_{y})O_{3-δ}), LNF (La(Ni_{1-y}Fe_{y})O_{3-δ}), LSF (La₁₋ₓ Srₓ)FeO_{3-δ}, and wherein the ionic phase can be Y stabilized zirconia, Sc stabilized zirconia, or a rare earth metal doped ceria, such as Gd, Sm, La, Nd, Dy, Er, Yb, Pr, Ho. The perovskite may comprise >20 v % and ≦100 v % of the cathode, and the ionic ceramic phase may comprise ≧0 and <70 v % of the cathode.

The method comprises operating the one or more fuel cells, fuel cell stacks, or fuel cell systems in a fuel cell mode at a first average current density, which may be an average current density of 100 to 1000 mA/cm², for a period of at least five hundred hours, and operating at least one of the fuel cells in an electrolyzer mode under a second average current density, which may be an average current density of 100 to 1500 mA/cm². In some embodiments, at least one fuel cell is operated in the electrolyzer mode for a period of at least one hour. In some embodiments, the one or more fuel cells may be operated in a fuel cell mode for a period of 500 to 10,000 hours. In some embodiments, the one or more fuel cells may be operated in a fuel cell mode for a period of 1,000 to 4,000 hours.

In some embodiments the fuel cell may be operated in electrolyzer mode for a period of 1 hour to 72 hours. In some embodiments, the fuel cell may be operated in an electrolyzer mode under an average current density from 400 to 1000 mA/cm² for a period of at least one hour. In some embodiments, the fuel cell may be operated in an electrolyzer mode under an average current density from 600 to 800 mA/cm² for a period of at least one hour.

In some embodiments, only a portion of the fuel cells of the fuel cell system may be operated in electrolysis mode. Operating only a portion of the fuel cells in electrolysis mode enables the reaming fuel cells, operating in fuel cell mode, to continue to meet electrical power demand. In some embodiments, the fuel cells operating in fuel cell mode may provide the reverse current used by the fuel cells operating in electrolysis mode. In some embodiments, one or more blocks, or a partial block of the fuel cell system may be operated in electrolysis mode.

In some embodiments, the ratio of the average current density of the electrolyzer mode to the average current density of the fuel cell mode may be between one and two and one-half.

### EXAMPLES

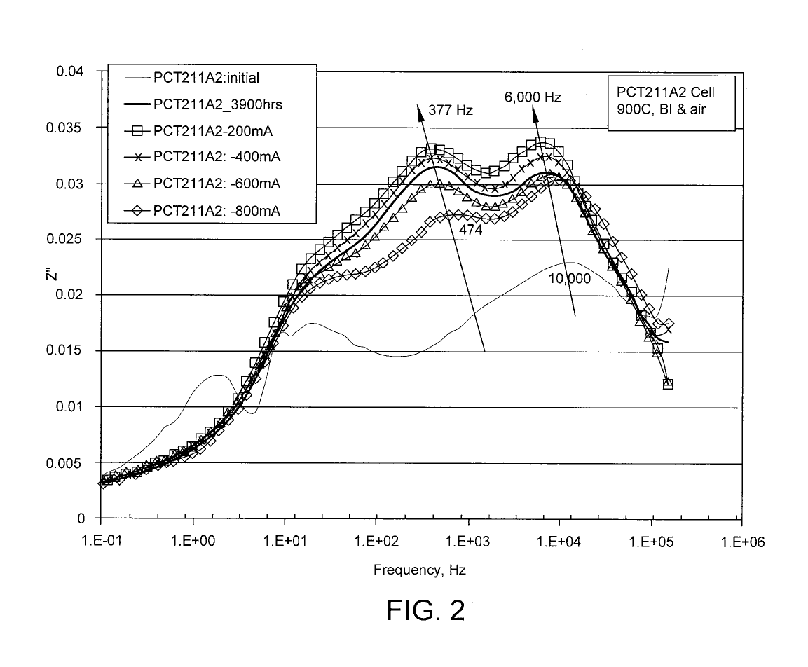

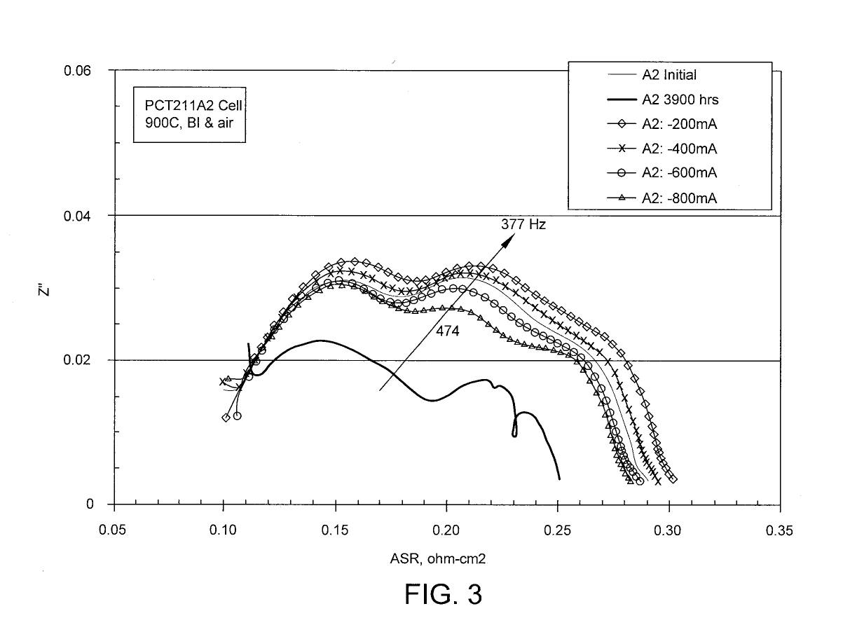

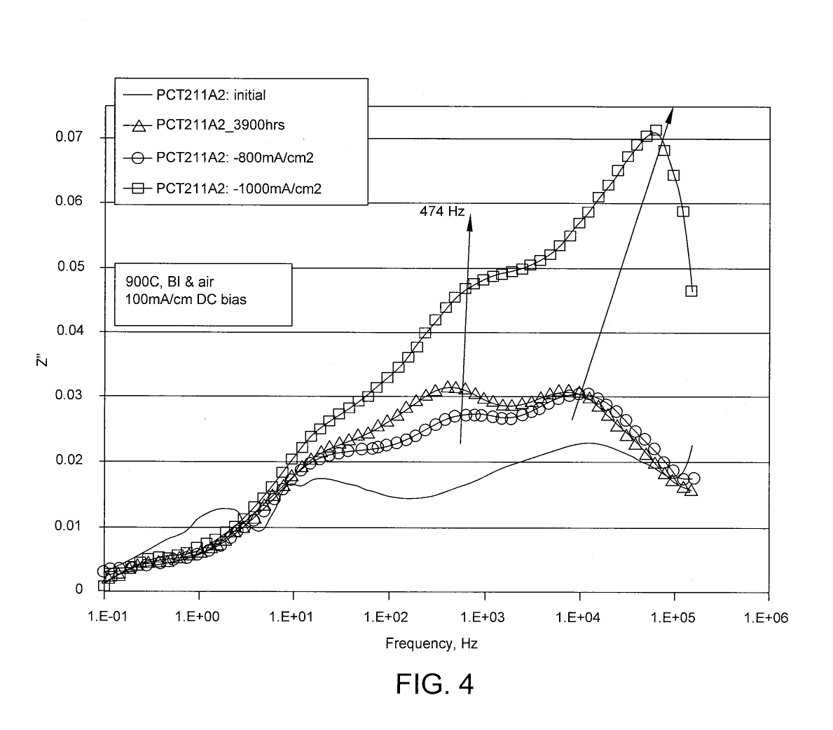

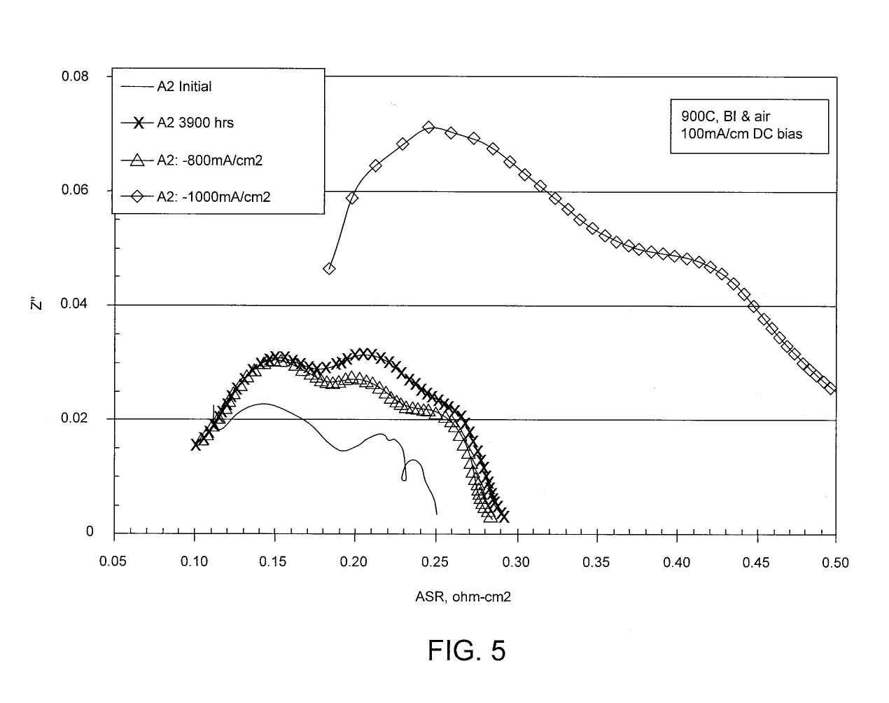

After 3,900 hours of fuel cell mode operations, a fuel cell was operated in electrolysis mode to regenerate the performance of a cathode of the fuel cell. The electrolysis mode operations consisted applying one of five separate reverse current densities (200, 400, 600, 800 and 1000 mA/cm²), in order of increasing magnitude, to the fuel cell for a period of three days. After each three day run, the performance of the fuel cell was measured prior to applying the next current density. FIG. 2-3 illustrates the AC impedance of a test article (“A2”) to show the change in electrode polarization after each application of the 200 to 800 mA/cm² reverse current densities (see FIGS. 4 and 5 for 800 and 1000 mA/cm² current densities). Cathode and anode resistance was represented by the peak around 374-474 Hz and 6,000 to 10,000 Hz, respectively. As can be seen, electrolysis mode at 200 and 400 mA/cm² produced slightly increased impedance in both electrodes. When the 600 to 800 mA/cm2 was applied in electrolysis mode, both electrodes showed improved performance.

FIGS. 4 and 5 illustrate the AC impedance of the A2 test article to show the change in electrode polarization after each application of the 800 to 1000 mA/cm² reverse current densities. As can be seen, both the cathode and the anode show a increase in resistance when operated in electrolysis mode at 1000 mA/cm². This may occur due to damage of the electrode, especially at the electrode-electrolyte interface. Reverse current operations at this level did not show improvements in electrode performance after only one hour and a higher degradation rate was observed.

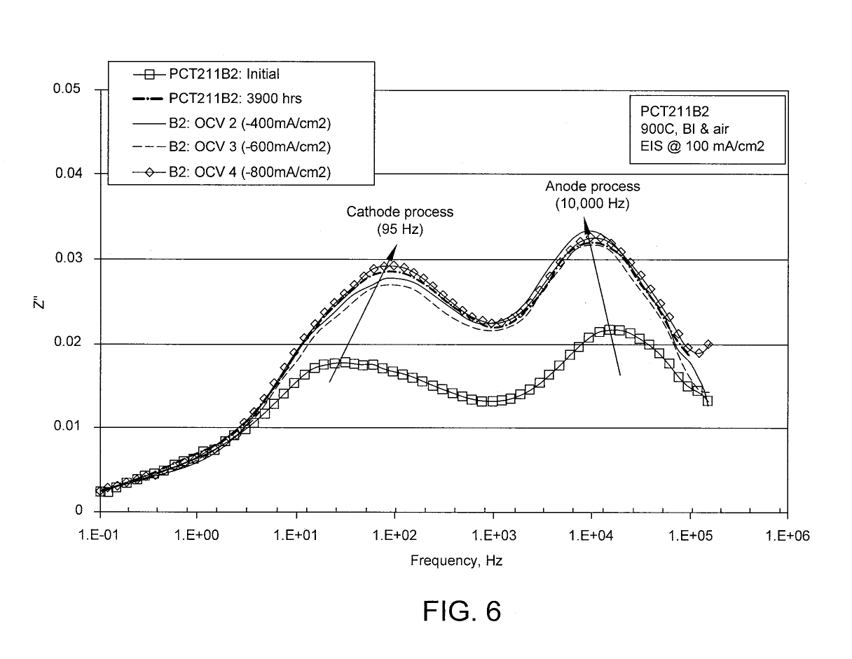

FIG. 6 illustrates a baseline fuel cell, test article B2, which was operated at the same fuel cell mode conditions in the same test rig as test article A2 (FIGS. 2 to 5), and held under open current voltage (OCV) while test article A2, the fuel cell of FIGS. 2-5, were operated under a reverse current. As can be seen, both the anode and cathode showed no significant changes in performance when the fuel cell is operated under OCV except for normal degradation resulting from thermal history.

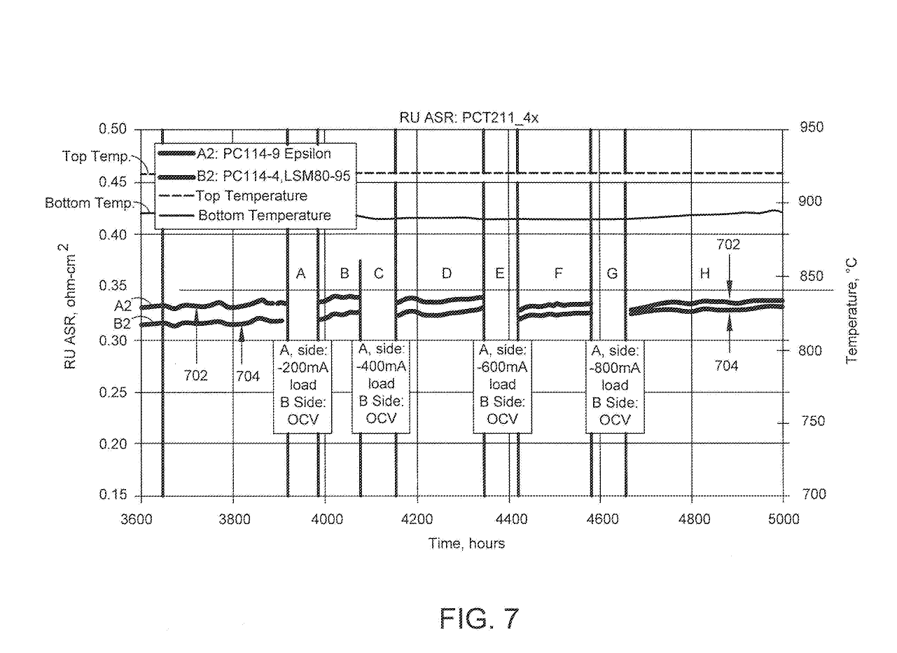

FIG. 7 illustrates the long term performance of two fuel cells. Curve 702 indicates the ASR of a fuel cell which is periodically operated with a reverse current to regenerate electrode performance. Curve 704 indicates the ASR of a fuel cell which is held under OCV during the periods in which the other fuel cell is operated in reverse current mode. Prior to the reverse current operations (which occur at points A, C, E, and G), there is a clear distinction between the curves 702 and 704. After reverse current operations at points E (600 mA/cm²) and G (800 mA/cm²) there is improvement in the ASR of the fuel cell represented by curve 702 while the ASR of the fuel cell represented by curve 704 continues to degrade.

While preferred embodiments of the present subject matter have been described, it is to be understood that the embodiments described are illustrative only and that the scope of the subject matter is to be defined solely by the appended claims when accorded a full range of equivalence, and the many variations and modifications naturally occurring to those of skill in the art from a perusal hereof.

We claim:

1. A method of operating a solid oxide fuel cell system comprising one or more fuel cells, said method comprising:
operating one or more of the fuel cells in a fuel cell mode under an average current density from 100 to 1000 mA/cm² for a period of at least five hundred hours; and
operating at least one of the fuel cells in an electrolyzer mode under an average current density from 100 to 1500 mA/cm².

2. The method of claim 1 comprising operating the one or more fuel cells in a fuel cell mode for a period of five hundred hours to ten thousand hours.

3. The method of claim 2 comprising operating the one or more fuel cells in a fuel cell mode for a period of one thousand hours to four thousand hours.

4. The method of claim 2, comprising operating the at least one fuel cell in an electrolyzer mode for a period of at least one hour.

5. The method of claim 4, comprising operating the at least one fuel cell in an electrolyzer mode for a period of one hour to seventy two hours.

6. The method of claim 1, comprising operating the at least one fuel cell in a electrolyzer mode for a period of at least one hour.

7. The method of claim 6 comprising operating the fuel cell in an electrolyzer mode for a period of one hour to seventy two hours.

8. The method of claim 1 comprising operating at least one of the fuel cells in an electrolyzer mode under an average current density from 400 to 1000 mA/cm² for a period of at least one hour.

9. The method of claim 8 comprising operating at least one of the fuel cells in an electrolyzer mode under an average current density from 600 to 800 mA/cm² for a period of at least one hour.

10. The method of claim 1 wherein the one or more fuel cells comprise an a composite cathode comprising a perovskite and an ionic ceramic phase.

11. The method of claim 10, wherein the perovskite comprises greater than 20 and less than 100% of the cathode by volume, and wherein the ionic ceramic phase comprises greater than 0 and less than 70% of the cathode by volume.

12. The method of claim 10, wherein the cathode comprises a composition selected from the group consisting of Pr₁₋ₓSrₓMnO_{3-δ}, (La₁₋ₓ, Srₓ)(Co_{1-y}Fe_{y})O_{3-δ}), (La(Ni_{1-y}Fe_{y})O_{3-δ}), and LSF (La₁₋ₓSrₓ)FeO_{3-δ}.

13. The method of claim 10, wherein the ionic ceramic phase comprises a composition selected from the group consisting of Y stabilized zirconia, and Sc stabilized zirconia.

14. The method of claim 10, wherein the ionic ceramic phase comprises a rare earth metal doped ceria.

15. The method of claim 14, wherein the rare earth metal doped ceria comprises an element selected from the group consisting of Gd, Sm, La, Nd, Dy, Er, Yb, Pr, and Ho.

16. The method of claim 1 wherein the one or more fuel cells comprise a composition having the formula La₁₋ₓSrₓMnO_{3-δ}.

17. The method of claim 1 comprising operating a plurality of fuel cells in a fuel cell mode and operating only a portion of the plurality of fuel cells in an electrolyzer mode.

18. A method of operating a solid oxide fuel cell comprising:
operating one or more fuel cells in a fuel cell mode under a current density from 100 to 1000 mA/cm² for a period of at least one thousand hours; and
operating at least one of the fuel cells in an electrolyzer mode under an average current density from 600 to 800 mA/cm² for a period of at least one hour.

19. The method of claim 18 wherein the ratio of the average current density in the electrolyzer mode to the average current density in the fuel cell mode is at least one but no more than two and one-half.

20. A method of operating a fuel cell system comprising:
operating one or more fuel cells of said fuel cell system in a fuel cell mode at a first average current density; and
operating at least one of said fuel cells in an electrolyzer mode at a second average current density,
wherein the ratio of the second average current density to the first average current density is at least one but no more than two and one-half.
